(19) United States
(12) Patent Application Publication
(10) Pub. No.: US 2002/0132545 A1
(43) Pub. Date: Sep. 19, 2002

(54) Wound dressing and/or compress with one or more nonwoven layers

(75) Inventor: Dirk Lenz, Hamburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(73) Assignee: Beiersdorf Aktiengesellschaft, Hamburg (DE)

(21) Appl. No.: 09/940,565

(22) Filed: Aug. 28, 2001

(30) Foreign Application Priority Data
Sep. 14, 2000 (DE) 100 45 462.3

(51) Int. Cl. B32B 5/02; B32B 27/04; B32B 27/12; D04H 1/00; D04H 3/00; D04H 5/00; D04H 13/00; B32B 5/26; B32B 27/32; D04H 3/16

(52) U.S. Cl. 442/382; 442/327; 442/394; 442/398; 442/401; 442/123

(57) ABSTRACT

A wound dressing and/or compress comprising a skin facing layer of a spunbond and at least one layer of a staple fiber nonwoven disposed on said spunbond, wherein the layers are nondetachably bonded together by ultrasonic welding.

This invention relates to a wound dressing and/or compress with a plurality of nonwoven layers, especially to an ultrasonically bonded wound dressing and/or compress.

Existing wound dressings and/or compresses for medical purposes include numerous materials based on film, woven fabric, loop-formingly knitted fabric, web, gel or foam. These sheetlike materials, which are also used in commercial practice, have to be highly absorbent, skin compatible, air and moisture vapor pervious and also highly conformable and compliant. But wound dressings and compresses must also be sufficiently strong for handling and in use. The backing material, furthermore, should possess sufficient strength and low extensibility even when wet through.

A wound dressing has to meet the following requirements:

The wound dressing needs to be highly absorbent for wound fluid, but also exhibit sufficient wet strength.

The wound dressing needs to protect the wound reliably against the ingress of foreign objects, and may adhere only a little if at all to the wound.

The wound dressing must not lead to irritation in the covered tissue.

The wound dressing shall be highly compliant to contoured body parts.

The wound dressing shall be pervious to gas and moisture vapor.

The wound dressing shall further permit combination with medicaments.

Nonwovens are particularly useful as a wound dressing or compress. They are generally air pervious, less costly to manufacture than wovens or formed-loop knits if common fiber materials are used and confer a high quality tactile experience. Common nonwovens for plaster applications have the disadvantage of limited elasticity and hence of not being ideally suitable for contoured parts of the body.

Nonwovens can be produced by various processes, for example by the dry process, the spunbond process or wet processes. Production is followed by a number of upgrading steps. Chemical binders are used in some instances (drylaid webs) which entail the disadvantage of undesirable chemical substances in the vicinity of the wound on use of the plaster.

Nonwovens for medical applications in wound dressings and compresses are consolidated for example thermally or mechanically, so that the ready produced nonwoven does not come into contact with any further process or auxiliary chemicals in the course of production. Materials produced by this process are consequently particularly useful in medical products such as dressing materials for example.

Conventional nonwoven wound dressings and universal compresses consist of the combination of two functional layers, a nonadherent wound contact layer and a distributor and/or storage layer.

The surface which comes directly into contact with the wound (the primary dressing) is particularly responsible for the wound compatibility of the dressing. There must not be any adhesion to the wound after blood coagulation. This functional layer of the primary wound dressing is formed by a specific nonwoven or a perforated film or a gauze. Under no circumstances may substances get into the wound from this layer. This imposes particular requirements on the selection of raw materials for fabricating these layers, which is why the choice frequently falls on nonwovens or films of wholly synthetic, hydrophobic fibers. On the other hand, the passage of exudate through the nonadherent wound contact layer must be ensured.

The layers above the primary wound dressing are responsible for fluid/exudate absorption and its distribution in the compress/wound dressing (secondary wound dressing). This is where nonwovens are used which provide high intercapillary or intracapillary water absorption, and generally they are constructed from viscose or cotton fibers.

The two layers are customarily firmly bonded together by chemical binders or adhesives, which carries the risk of causing irritation to patients, or the primary wound dressing encloses the absorption layer.

The absorption layer predominantly utilizes nonwovens of cotton and viscose. Compresses and wound dressings composed of nonwovens with primary wound dressing can be cut to size as needed and still possess sufficient integrity or wet strength in that state.

Tappi J. (1989), 72 (5), 165-70, provides a general overview of the technology for the ultrasonic bonding of nonwovens:

Ultrasonic bonding is a benign process.

It does not involve high temperatures which could damage the material.

Ultrasonic processes are particularly suitable for polyolefins, since they have a relatively low melting point.

The process is faster than thermal bonding

The bonding process is suitable for bonding particularly lofty materials together. Very good interbonding of the layers is obtained as well as a soft hand.

U.S. Pat. No. 5,607,798 discloses a laminate of three thermally bonded layers, said laminate comprising

a nonwoven comprised of a biconstituent blend

of from 50 to 95% by weight isotactic polypropylene and

from 5 to 50% by weight of a random block copolymer of propylene and ethylene having a melting point of below 160° C.,

an interlayer consisting of a film or a meltblown nonwoven fabric and a polypropylene spunbond.

The three layers are bonded together by thermal bonding, ultrasonic welding, hydroentanglement or needling.

WO 96/23095 describes the consolidation step of spunbonds of polypropylene by thermal point bonding, ultrasonic welding or through air bonding and ultrasound. For better performance in the bonding process, syndiotactic polypropylene is used together with isotactic polypropylene, in a ratio of 2 to 15%:85 to 98%.

As a result, the processing temperature in the thermal bonding process decreases by 10° F. compared with a similar thermoplastic polypropylene web without addition of syndiotactic polypropylene.

It is an object of the present invention to provide a web based wound dressing and/or compress which is highly suitable for the stated requirements and which does not have the disadvantages known from the prior art.

This object is achieved by a web as set out in claim 1. The subclaims comprehend advantageous variants of the subject matter of the invention and also processes for producing the wound dressing and/or compress.

The invention accordingly provides a wound dressing and/or compress comprising a skin facing layer of a spunbond and at least one layer of a staple fiber nonwoven disposed on said spunbond, wherein the layers are nondetachably bonded together by ultrasonic welding.

Such wound dressings are constructable using nonwovens which ensure an absorption capacity of 600 to 1000 g/m² (DIN 53923). The distributor or storage layer customarily utilizes nonwovens of hydrophilic fibers, such as viscose or cotton, used together with a bonding fiber (polyester/polypropylene).

In a preferred embodiment, the staple fiber webs and spunbonds consist of polypropylene.

This is because—surprisingly to one skilled in the art—staple fiber nonwovens of pure polypropylene combined with a polypropylene spunbond exhibit the absorption capacity of >700 g/m² typical of wound dressings.

This absorption capacity rests on the intercapillary storage capacity of the nonwoven, i.e., the three-dimensional arrangement of the fibers in space, and the nature and the degree of compaction of the fibers.

The nonadherent wound contact layer preferably utilizes a polypropylene spunbond having a basis weight of about 8 to 25 g/m².

The distributor or storage layer advantageously utilizes absorbent staple fiber nonwovens of in particular polypropylene having a basis weight of about 15 to 35 g/m².

It is advantageous for the number of layers of the staple fiber nonwovens not to exceed five.

The spunbond and staple fiber webs are produced in a manner known to those skilled in the art.

A customary process for interbonding the two layers of the nonwoven is the gravure roll calendering of two layers while heating at the melting temperature of the polymer. The two nonwovens are intensively joined together at the raised points. This provides a good bond which meets the basic requirements of a wound dressing.

Disadvantages of the thermal laminating process are the tendency to delaminate and the possibly insufficient wet strength.

An alternative economical principle for producing these functional nonwoven wound dressings and compresses consists in bonding staple fiber webs and spunbonds comprising polypropylene for example together by ultrasonic welding.

Up to seven layers of hygiene standard nonwovens are inseparably bonded together ultrasonically.

In a quality determining step, the layers of the staple fiber nonwovens and the layer of the spunbond are welded together ultrasonically. The construction is such that the wound facing side comprises a spunbond having a smooth surface, which ensures the necessary nonadherence to the wound. The staple fiber web layers underneath provide for absorption and storage of the wound exudate (absorbent pad) (see FIG. 2).

The weld points can be varied by varying the mask in the ultrasonic unit above the sonotrode.

In the case of a diagonal structure for the weld points, these should preferably be spaced between 2 and 5 mm, especially 3 mm to 4 mm, apart in the longitudinal and transverse directions of the nonwoven, since this provides an optimal splitting resistance for the wound dressing/compress.

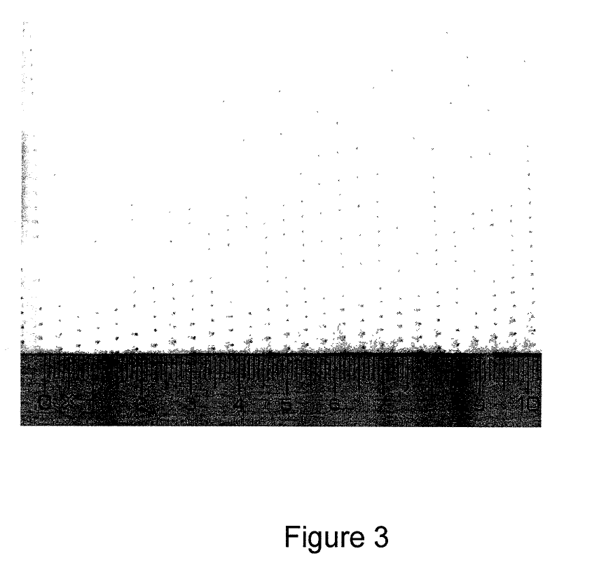

FIG. 3 illustrates a material according to the invention.

Ultrasonic welding is an efficient process of lamination without high temperatures and it is also benign, especially in the case of the production of wound dressings for labile finishes (active substances) which are already present in one of the components. Lastly, significant parameters such as absorption capacity or bending stiffness can be positively influenced.

Furthermore, in particular embodiments of the wound dressing/compress, said spunbond

is doped with active substances and/or

finished with bactericidal and/or fungicidal substances and/or

microencapsulated cosmetically active substances.

The minimally absorbent nonadherent wound contact layer is finished with the active substance and then laminated ultrasonically to the other layers of the absorbent pad. This results in an inseparable composite of finished nonadherent wound contact layer and absorbent pad. The active substance loaded spunbond is subjected by the ultrasonic welding process only to insignificant thermal stress. Hence even thermally unstable formulations can be used for this construction. The active substance is located on the upper surface of the compress/wound dressing, so that the concentration of the active substance can be kept small.

The concept of the invention further comprehends an ultrasonically consolidated wound dressing and/or compress which is produced by welding together a perforated film (preferably comprised of PP) as nonadherent wound contact layer and standard hygiene nonwovens as a storage layer. Here, the perforated film assumes the function of the spunbond in the previously described variant. The perforated film becomes thermoplastically bonded to the layers of the absorbent pad in the course of the ultrasonic welding and constitutes an excellent composite.

A further particular construction is provided by combining the two previously described variants: a perforated film, a spunbond and a plurality of layers of an absorbent staple fiber nonwoven are bonded together by ultrasonic welding. Film and spunbond assume the function of the nonadherent wound contact layer.

A particularly advantageous embodiment of the wound dressing according to the invention will now be described with reference to a plurality of figures without thereby wishing to unnecessarily restrict the invention.

Specifically, by way of illustration of the construction of the present invention,

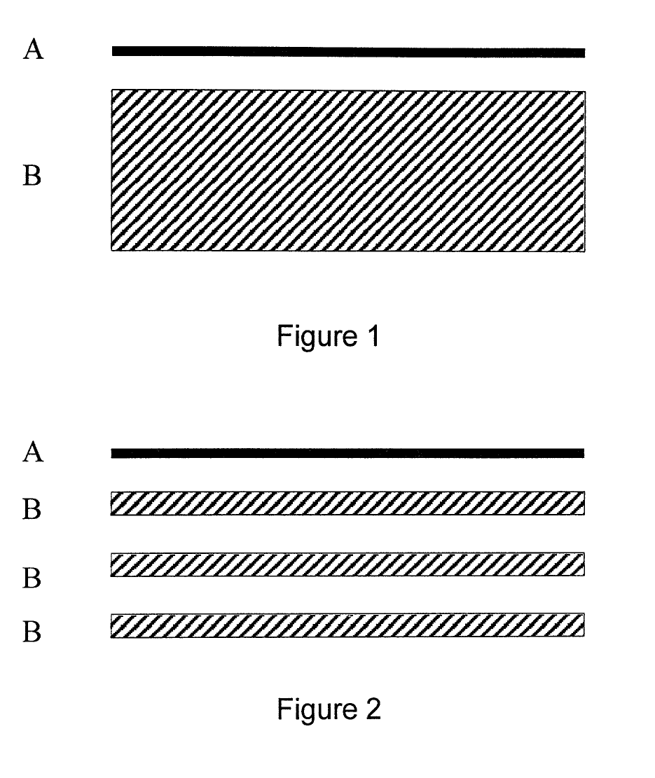

FIG. 1 shows the construction of nonwoven universal compresses/wound dressings,

FIG. 2 shows the layered construction of an ultrasonically welded compress or wound dressing,

FIG. 3 shows an advantageous embodiment of the ultrasonically consolidated wound dressing.

FIG. 1 shows the construction of wound dressings from two functional layers by thermal lamination. The spunbond, having a smooth surface, faces the wound. FIG. 2 shows the multilayered construction of an ultrasonically consolidated nonwoven wound dressing constructed from a plurality of layers of standard hygiene nonwovens.

### EXAMPLE

The physical data of wound dressings are compared: three ultrasonically consolidated PP wound dressings/compresses according to the invention (inventive examples 1 to 3) with a thermally laminated PP wound dressing/compress (comparative example).

TABLE 1
Construction of materials:

| | Comparative | Inventive | Inventive | Inventive |
|---|---|---|---|---|
| Feature | example | example 1 | example 2 | example 3 |
| Construction/type: | Thermally | Ultrasonically | Ultrasonically | Ultrasonically |
| | laminated | laminated | laminated | laminated |
| | 2 layers | 4 layers | 5 layers | 7 layers |
| Nonadherent | 15 g/m² PP | 2 × 20 g/m² PP | 2 × 20 g/m² PP | 2 × 20 g/m² PP |
| wound contact | spunbond | spunbond | spunbond | spunbond |
| layer | | | | |
| Storage/distributor | 100 g/m² PP | 2 × 20 g/m² PP | 3 × 20 g/m² PP | 5 × 20 g/m² PP |
| layer | staple fiber web | staple fiber web | staple fiber web | staple fiber web |

TABLE 2
Physical properties:

| | | Com- | | | |
|---|---|---|---|---|---|
| Feature/ | | parative | Inventive | Inventive | Inventive |
| method | Unit | example | example 1 | example 2 | example 3 |
| Basis weight | g/m² | 115 | 87 | 111 | 162 |
| DIN EN | | | | | |
| 29073 P1 | | | | | |
| Thickness | mm | 0.99 | 0.67 | 0.84 | 01.03 |
| DIN EN | | | | | |
| 29073 P1 | | | | | |
| UTS strength | N/50 mm | 27.5 | 158 | 188 | 279 |
| along | | | | | |
| DIN EN | | | | | |
| 29073 P3 | | | | | |
| UTS strength | N/50 mm | 13 | 65 | 71 | 93 |
| across | | | | | |
| DIN EN | | | | | |
| 29073 P3 | | | | | |
| Separating | N/50 mm | 1.2 | nd* | nd* | nd* |
| force | | | | | |
| DIN 53357 | | | | | |
| Water | g/m² | 850 | 650 | 500 | 570 |
| absorption | | | | | |
| DIN 53923 | | | | | |
| Bending | cN*cm² | 3.28 | 2.27 | 4.06 | 9.64 |
| stiffness | | | | | |
| along | | | | | |
| Bending | cN*cm² | 0.94 | — | — | — |
| stiffness | | | | | |
| across | | | | | |

*nd = not determinable since the compress/wound dressing breaks before the layers separate

Comparing the data shows the particular properties of the compress/wound dressing produced by ultrasonic consolidation compared with the conventional thermally laminated variant.

Values of the ultimate tensile stress strengths in the longitudinal and transverse directions are higher by a factor of five than in the case of the conventional variant.

A further important parameter is the separating force of the layers. Whereas in the case of the thermally laminated variant the separating force was only 1.2 N/50 mm, the layers of the ultrasonic variants were no longer separable without completely destroying the compress/wound dressing.

This property is of immense importance for medical use in particular, in order that the compress may not split when used on the wound and the upper nonadherent wound contact layer may possibly remain in the wound.

The water absorption is slightly down for the ultrasonic variants. The reason for this is the different layer construction. It is a composite with a plurality of layers in the storage layer, which each by itself is more highly consolidated than a material consisting of one storage layer only. The higher degree of consolidation of the individual web layers as a result leads to a reduced absorption of liquid in the ready produced product.

What is claimed is:

1. A wound dressing and/or compress comprising a skin facing layer of a spunbond and at least one layer of a staple fiber nonwoven disposed on said spunbond, wherein the layers are nondetachably bonded together by ultrasonic welding.

2. The wound dressing and/or compress of claim 1, wherein said spunbond and said staple fiber nonwoven consist of polypropylene.

3. The wound dressing and/or compress of claims 1 and 2, wherein said staple fiber nonwoven has a basis weight of 15 to 35 g/m² and/or the spunbond has a basis weight of 8to25g/m².

4. The wound dressing and/or compress of any of claims 1 to 3, wherein the backing material includes up to five layers of said staple fiber nonwoven.

5. The wound dressing and/or compress of any of claims 1 to 4, wherein said spunbond
is doped with active substances
and/or finished with bactericidal
and/or fungicidal substances
and/or microencapsulated cosmetically active substances.

6. The wound dressing and/or compress of any of claims 1 to 5, wherein the spunbonds have had added to them high strength fibers, folded yarns, folded union yarns or threads having an ultimate tensile stress strength of at least 60 cN/tex.

7. A process for producing a wound dressing and/or compress as claimed in claim 7, which comprises spacing the weld points apart in the longitudinal and transverse directions at a distance between 2 and 5 mm, especially 3 mm to 4 mm.

8. A wound dressing and/or compress comprising a skin facing layer of a perforated film and at least one layer of a nonwoven disposed on said perforated film, wherein the layers are nondetachably bonded together by ultrasonic welding.

9. The wound dressing and/or compress of claim 8, wherein said film consists of polypropylene.

10. The wound dressing and/or compress of claims 8 and 9, wherein said nonwoven has disposed on it at least one layer of a spunbond, the layers being nondetachably bonded together.
